(19) United States
(12) Patent Application Publication
(10) Pub. No.: US 2006/0049011 A1
(43) Pub. Date: Mar. 9, 2006

(54) Floating disc brake assembly with interlocking hub and rotor

(75) Inventor: William V. Jacob, Chagrin Falls, OH (US)

Correspondence Address: WHYTE HIRSCHBOECK DUDEK S C, 555 EAST WELLS STREET, SUITE 1900, MILWAUKEE, WI, 53202, US

(73) Assignee: Hayes Brake, LLC

(21) Appl. No.: 11/090,702

(22) Filed: Mar. 24, 2005

Related U.S. Application Data
(60) Provisional application No. 60/555,842, filed on Mar. 24, 2004.

(51) Int. Cl. F16D 65/12

(52) U.S. Cl. 188/218 XL; 188/18 A

(57) ABSTRACT

A floating disc brake assembly comprises a hub and a rotor in mating alignment therewith through one or more interlocking lobes that are alternatingly arranged about an outer peripheral edge of the hub and an internal edge of the rotor. The rotor is coupled to, and disposed circumferentially around, the hub. As a friction element is applied to the rotor to decrease rotation thereof during a braking operation, the interlocking lobes transmit brake torque from the rotor to the hub through a gap existing therebetween. The gap retards heat flow. The gap also permits radial float. Differing hub and rotor widths, or a floating clearance between a fastener and the hub, both permit axial float. Warpage and knockback of the rotor are reduced.

### CROSS-REFERENCES TO RELATED APPLICATIONS

This application claims priority under 35 U.S.C. § 119(e) to U.S. Provisional Patent Application Ser. No. 60/555,842, filed on Mar. 24, 2004, the entire disclosure of which is hereby incorporated by reference.

### STATEMENT REGARDING FEDERALLY SPONSORED RESEARCH OR DEVELOPMENT

### REFERENCE TO MICROFICHE APPENDIX

### BACKGROUND OF THE INVENTION

1. Field of the Invention

This invention relates to disc brakes, and, more specifically, to floating disc brake assemblies, as commonly used, for example, with motorized vehicles such as snowmobiles, ATVs, and the like.

2. Description of Related Art

Many types of disc brakes are well-known, including, for example, floating disc brake assemblies comprising a hub and a floating rotor.

As with all mechanical braking systems, disc brake assemblies retard rotary motion of a rotor—which, in turn, usually retards rotary motion of an axle shaft connected thereto—by converting mechanical energy into heat in accordance with well-known principles. More specifically, disc brake assemblies retard rotary motion of the rotor by applying a friction element thereto, and this forced contact between the friction element and the rotor generates the afore-mentioned heat. In general terms, the friction element and the rotor are joined or otherwise urged together by external forces acting thereupon, thereby effectuating braking.

Like all braking systems, frictional disc brake systems must be capable of withstanding, absorbing, or otherwise dissipating the heat generated by braking. Otherwise, the braking components will become heated to temperatures at which they will fail, for example, by i) causing vibrations across the disc brake assembly, which can result in rough or irregular braking sensations, or ii) ultimately warping, fracturing, or otherwise deteriorating the hub, the rotor, or other braking components, thereby ultimately deteriorating the performance of the entire disc brake assembly, or increasing the maintenance costs thereof, or worse.

If the rotor is fixed with respect to the hub (i.e., a non-floating disc brake assembly), accommodating thermal expansion of the rotor during braking is limited because of the integrated connection between the rotor and the hub. This fixed arrangement can create a large thermal gradient and large thermal discrepancies in the rotor, which can induce high thermal stresses and cause the entire disc brake assembly to fail.

Even if the rotor is allowed to float with respect to the hub, however, adequately accommodating thermal expansion of the rotor during braking has also been largely unsatisfactory. Nevertheless, adequately allowing for this thermal expansion is particularly important in numerous disc brake assemblies, including, for example, disc brake assemblies commonly used in snowmobiles, ATVs, and the like.

Accordingly, the present invention will provide a floating disc brake assembly comprising a hub and a rotor in mating alignment therewith through one or more interlocking lobes that are alternatingly arranged about an outer peripheral edge of the hub and an internal edge of the rotor, in which many of the afore-mentioned concerns are minimized or altogether eliminated.

### SUMMARY OF THE INVENTION

A floating disc brake assembly comprises a rotatable brake hub and a rotor disposed circumferentially around the hub. The rotor is adapted to rotate with an axle when the hub is connected thereto and has an outer peripheral edge. The rotor has an internal edge that is in mating alignment with the outer peripheral edge or the hub through one or more interlocking lobes that are alternatingly disposed about the outer peripheral edge of the hub and the internal edge of the rotor.

In a preferred embodiment, at least one of the interlocking lobes is dimensioned to create a gap between the outer peripheral edge of the hub and the internal edge of the rotor. The gap permits radial floatation between the hub and the rotor. It also permits the rotor to expand radially during a thermal condition. In addition, the gap absorbs heat generated by a friction element during a braking operation in order to retard heat flow from the rotor to the hub.

In another preferred embodiment, at least one of the interlocking lobes provides an interactive driving connection between the hub and the rotor. At least one of the interlocking lobes transmits torque between the hub and the rotor.

In another preferred embodiment, the floating disc brake assembly further comprising one or more fasteners connecting the hub to the rotor. The fasteners restrict axial disengagement between the hub and the rotor. The fasteners also permit axial floatation between the hub and the rotor.

In another preferred embodiment, differing hub and rotor widths permit axial floatation therebetween.

In another preferred embodiment, the hub and the rotor float radially, axially, or both relative to one another.

In another preferred embodiment, the floating disc brake assembly reduces one or both of failure of the rotor or knockback.

In another preferred embodiment, at least one of the interlocking lobes comprises a neck portion that is smaller than a body portion thereof.

In another preferred embodiment, the interlocking lobes increase surface area contact between the hub and the rotor.

In addition, a floating disc brake assembly comprises a rotatable brake hub adapted to rotate with an axle when the hub is connected to said axle; and a rotor disposed circumferentially around the hub, the rotor attached to the hub by one or more interlocking lobes in mating arrangement extending therebetween.

In a preferred embodiment, at least one of the interlocking lobes alternatingly extends about the hub and the rotor.

In another preferred embodiment, if a thermal condition creates a radial size differential between the hub and the rotor, the interlocking lobes restrict radial separation between the hub and the rotor.

### BRIEF DESCRIPTION OF THE SEVERAL VIEWS OF THE DRAWINGS

A clear conception of the advantages and features constituting inventive arrangements, and of various construction and operational aspects of typical mechanisms provided therewith, will become readily apparent by referring to the following exemplary, representative, and non-limiting illustrations, which form an integral part of this specification, wherein like reference numerals generally designate the same elements in the several views, and in which:

FIG. 1 is a first view of a floating disc brake assembly comprising a rotor coupled to, and disposed around, a rotatable brake hub according to a preferred embodiment of the inventive arrangements;

FIG. 2 is an additional detail view of the hub and a portion of the rotor of the floating disc brake assembly of FIG. 1;

FIG. 3 is an additional detail view of a preferred interlocking lobe according to the inventive arrangements;

FIG. 4 is a simplified cross-sectional view of a preferred fastener affixing the rotor to the hub;

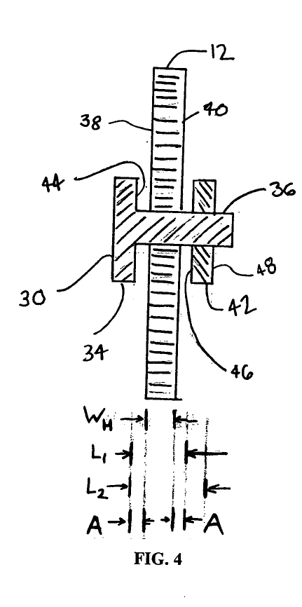

FIG. 5 is a second view of the floating disc brake assembly according to the inventive arrangements, the second view being generally opposite the first view of FIG. 1; and

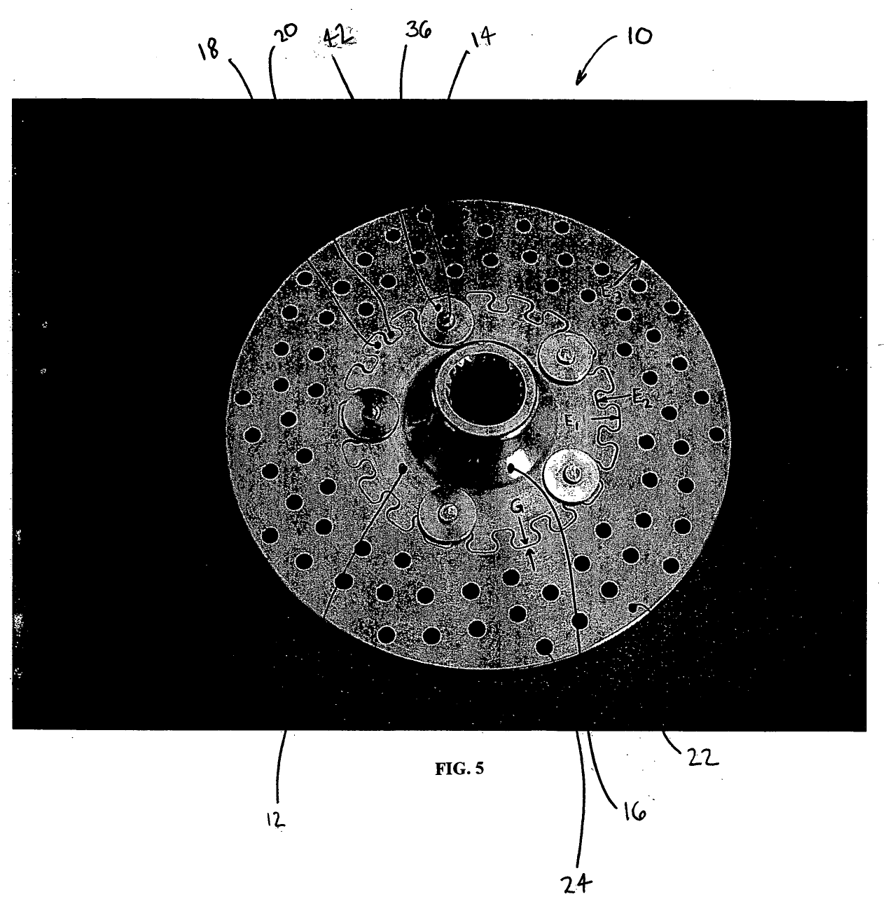

FIG. 6 is a side view of the floating disc brake assembly according to the inventive arrangements.

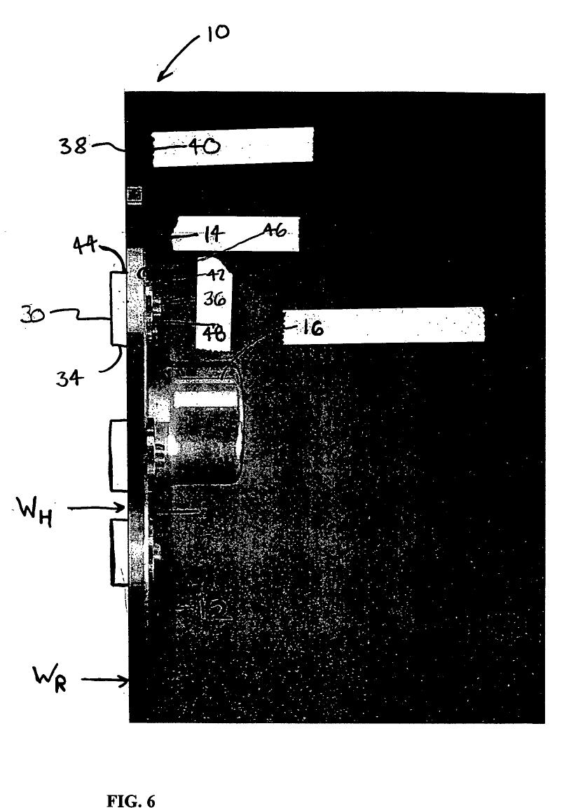

### DETAILED DESCRIPTION OF PREFERRED EMBODIMENTS

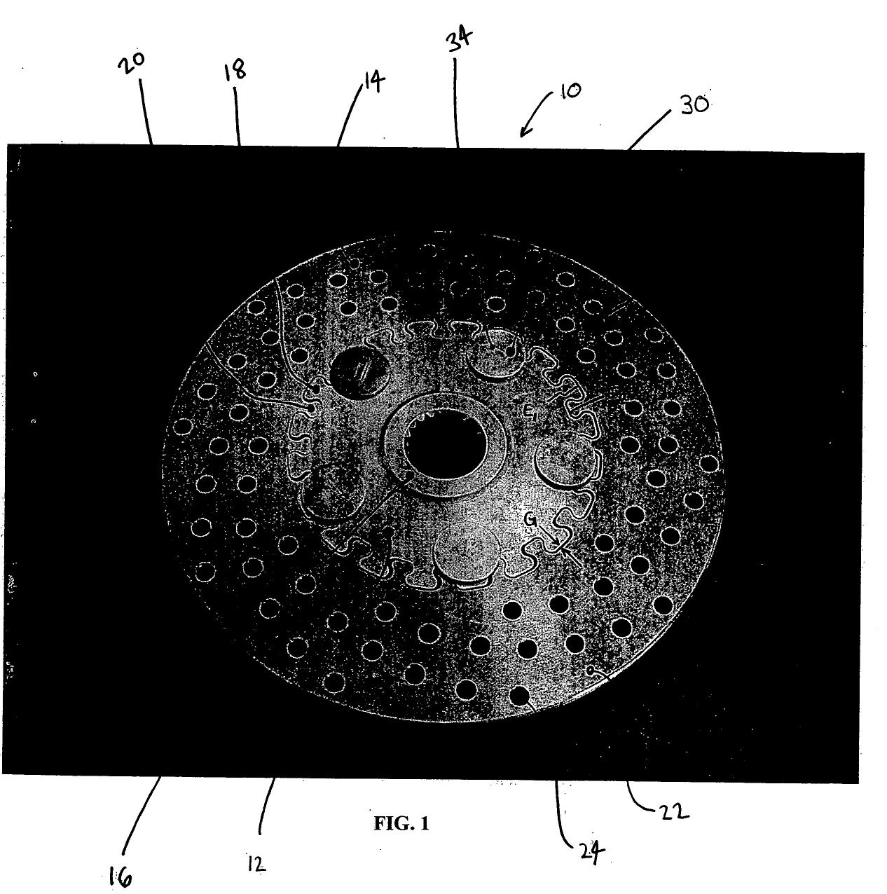

Referring now to FIG. 1, a first view is provided of a disc brake assembly 10 comprising a brake hub (hereinafter, hub) 12 and a rotor 14. More specifically, both the hub 12 and the rotor 14 are generally semi-circular in shape, with the rotor 14 coupled to, and disposed circumferentially around, the hub 12. As such, the rotor 14 annularly surrounds the hub 12, whereby the hub 12 and the rotor 14 are concentrically arranged about a common axis. Accordingly, the hub 12 and the rotor 14 are floatably connected to one another such that an axis of rotation of the hub 12 is generally the same as, or at least generally aligned with, an axis of rotation of the rotor 14, and vice versa.

In floating disc brake assemblies 10, the hub 12 and the rotor 14 are separate components. In various embodiments, they can be fabricated or formed from separate materials. And they can be chosen from conventional forms and materials commonly used in braking applications. For example, they can be conventionally chosen from known materials that specifically enhance thermal performance of the disc brake assembly 10, depending, at least in part, on desired applications, performance, cost, and other like considerations.

In operation, the hub 12 is drivingly engaged to an axle shaft (not shown) that supports a wheel, a track, or the like. Accordingly, the hub 12 and the axle shaft are rotatably secured to one another by techniques known in the art. As such, the hub 12 is connected to the axle shaft in order to be rotated therewith. Accordingly, the hub 12 may comprise an internal mount 16 for mounting to the axle shaft. In a preferred embodiment, the hub 12 and the internal mount 16 are of unitary construction or fabricated or formed from a common material. Regardless, the hub 12 is supported axially and radially by the axle shaft and receives rotatable power therefrom. The hub 12 also includes an outer peripheral edge E₁ comprising a plurality of alternating circumferential lobes 18.

In complimentary fashion, the rotor 14 also includes an internal edge E₂ comprising a plurality of alternating circumferential lobes 20, as well as an outer peripheral edge E₃. As such, the internal edge E₂ and the outer peripheral edge E₃ of the rotor 14 define therebetween a generally flat annular braking surface 22, in which a friction element (not shown) is preferably dimensioned to contact only the flat annular braking surface 22 of the rotor 14 and not the hub 12. In other words, the friction element is preferably dimensioned to act between the internal edge E₂ and the outer peripheral edge E₃ of the rotor 14. This promotes effective braking operations without unduly effecting the hub 12 or the friction element. In a preferred embodiment, the rotor 14 is also provided with one or more vent holes 24 along its flat annular braking surface 22 in order to further effectuate effective heat transfer through the rotor 14 (although only one vent hole 24 is labeled in the figures for simplicity).

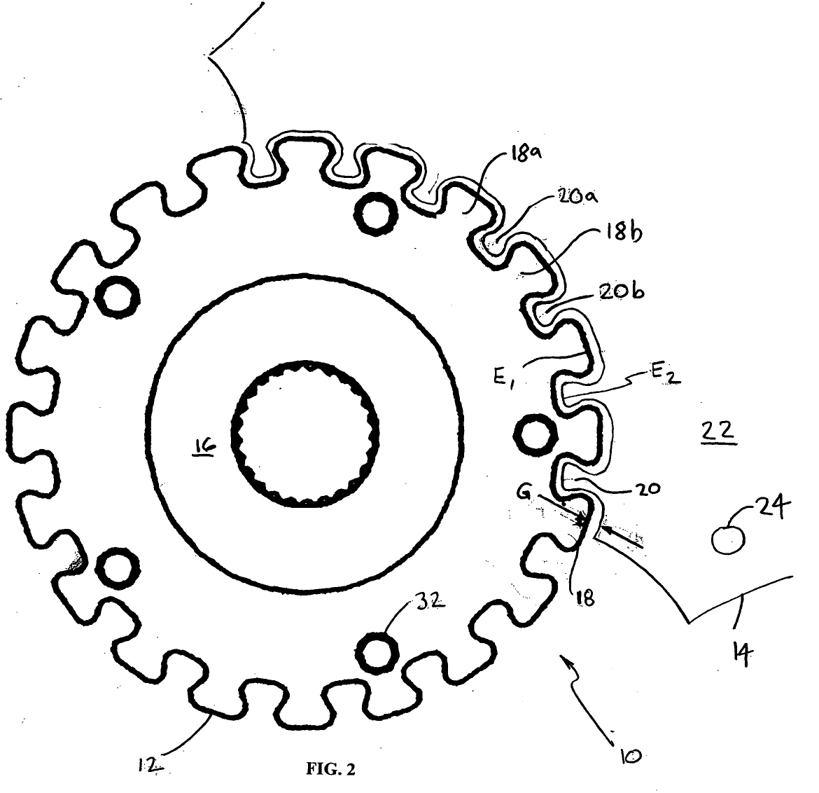

Referring now to FIG. 2, the outer peripheral edge E₁ of the hub 12 and the internal edge E₂ of the rotor 14 are in reciprocal mating alignment with one another when brought together. More specifically, the lobes 18 of the hub 12 are alternatingly aligned with the lobes 20 of the rotor 14. Preferably, the lobes 18 of the hub 12 extend about the entire outer peripheral edge E₁ of the hub 12, and the lobes 20 of the rotor 14 likewise extend about the entire internal edge E₂ of the rotor 14 (although only a few the lobes 18, 20 are labeled in the figures for simplicity). In this fashion, any two adjacent lobes 18a, 18b on the outer peripheral edge E₁ of the hub 12 mate with an intermediate, corresponding lobe 20a on the internal edge E₂ of the rotor 14. Likewise, any two adjacent lobes 20a, 20b on the internal edge E₂ of the rotor 14 mate with an intermediate, corresponding lobe 18b on the outer peripheral edge E₁ of the hub 12. In this fashion, the hub 12 and the rotor 14 are radially aligned with one another about their generally common axis. As a result, the respective lobes 18, 20 connect and interlock with another, thereby radially securing the hub 12 and the rotor 14 together.

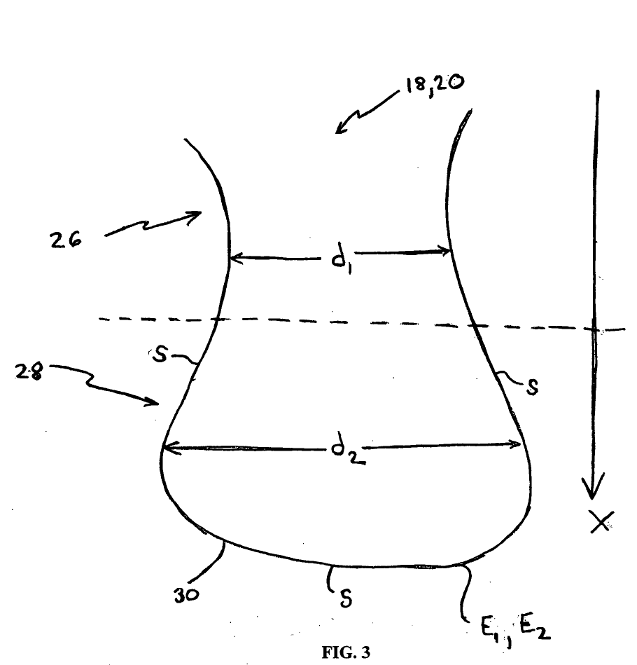

Referring now to FIG. 3, the lobes 18 of the hub 12 and the lobes 20 of the rotor 14 actively engage one another to prevent radial separation therebetween. For example, in a preferred embodiment of the inventive arrangements, this is accomplished by dimensioning the lobes 18, 20 to have a first dimension d₁ in a neck portion 26 thereof that is smaller than a second dimension d₂ in a body portion 28 portion thereof, as referenced in a direction X extending towards a distal end 30 of either of the lobes 18, 20. The physical material comprising this first dimension d₁ on the outer peripheral edge E₁ of the hub 12 allows the two adjacent lobes 18a, 18b of the hub 12 to frictionally engage the physical material comprising the second dimension d₂ on the internal edge E₂ of the rotor 14, thereby holding the hub 12 and the rotor 14 in the interlocking arrangement. Likewise, the physical material comprising this first dimension d₁ on the internal edge E₂ of the rotor 14 allows the two adjacent lobes 20a, 20b of the rotor 14 to frictionally engage the physical material comprising the second dimension d₂ on the outer peripheral edge E₁ of the hub 12, thereby holding the hub 12 and the rotor 14 in the interlocking arrangement. Accordingly, the lobes 18 of the hub 12 and the lobes 20 of the rotor 14 are arranged alternatingly about the respective outer peripheral edge E₁ of the hub 12 and the internal edge E₂ of the rotor 14. The lobes 18, 20 that define this interlocking arrangement increase the surface area contact between the outer peripheral edge E₁ of the hub 12 and the internal edge E₂ of the rotor 14. And, as a matter of design choice, the first dimension d₁ and the second dimension d₂ on a lobe 18 of the hub 12 need not be the same as the first dimension d₁ and the second dimension d₂ on a lobe 20 of the rotor 18, and vice versa. Rather, the lobes 18 of the hub 12 and the lobes 20 of the rotor 14 may employ the same or different first dimensions d₁ and the same or different second dimension d₂, as desired.

The lobes 18 of the hub 12 and the lobes 20 of the rotor 14 interfit between, and co-act with, one another. Preferably, they are equally and symmetrically spaced about the respective peripheral edge E₁ of the hub 12 and the internal edge E₂ of the rotor 14. As such, they provide an interactive driving connection between the hub 12 and the rotor 14, whereby rotation of the hub 12 drives rotation of the rotor 14, and retardation of the rotor 14 drives retardation of the hub 12. These lobes 18, 20 carry these respective torque forces between the hub 12 and the rotor 14, and vice versa. For example, when the axle shaft drives the hub 12 through the internal mount 16, the lobes 18 of the hub 12 rotatably drive the lobes 20 of the rotor 14. Likewise, when the friction element is applied to the flat annular braking surface 22 of the rotor 14, the lobes 20 of the rotor 14 rotatably retard the lobes 18 of the hub 12. In this fashion, rotational forces are reciprocally translated between the lobes 18 of the hub 12 and the lobes 20 of the rotor 14, and vice versa, and the increased surface area therebetween helps spread these forces over an increased area.

The interlocking lobes 18, 20 also inherently help center the rotor 14 about the hub 12. In addition, if the rotor 14 were to crack or otherwise break during a thermal yield condition of the disc brake assembly 10, this interfit between the lobes 18 of the hub 12 and the lobes 20 of the rotor 14 would further prevent damaged pieces of the hub 12 or rotor 14 from further separating from the disc brake assembly 10.

Referring again to FIGS. 1-2, the lobes 18 of the hub 12 and the lobes 20 of the rotor 14 are suitably dimensioned to allow a gap G to extend therebetween. More specifically, the gap G is defined between the corresponding, reciprocating, and adjacent lobes 18, 20. This gap G permits slight radial motion between the hub 12 and the rotor 14 relative to one another. As a result, it is not necessary for all of the surfaces S of all of the lobes 18 of the hub 12 to be in constant engagement with all of the surfaces S of all of the lobes 20 of the rotor 14. Rather, some adjacent lobes 18, 20 will, at any given time, be more engaged than other lobes 18, 20. As described, this gap G permits slight relative radial movements between the hub 12 and the rotor 14, as expressed at any of the given lobes 18, 20 at a given time. As described, this gap G also allows portions of the rotor 14 to move inwards towards the hub 12 at the same time that other portions of the rotor 14 move outwards away from the hub 12, these respective portions being on generally opposite sides of the hub 12. Accordingly, this gap G thus defines a dynamic clearance distance between the hub 12 and the rotor 14.

Advantageously, this gap G retards the transfer of heat from the rotor 14 to the hub 12 during a breaking operation, which is further bolstered by the increased surface area between the outer peripheral edge E₁ of the hub 12 and the internal edge E₂ of the rotor 14. As a result, when the friction element engages the flat annular braking surface 22 of the rotor 14 and begins to heat the same in order to slow or stop rotation thereof, this thermal expansion is tempered by the gap G and therefore has less of an effect on the hub 12. Accordingly, this gap G helps reduce or eliminate unnecessary distortion or warping of the hub 12 and the rotor 14.

More specifically, the rotor 14 experiences uniform heat expansion when exposed to the frictional heat generated by the braking operation-i.e., the rotational energy of the rotor 14 is converted into heat when the friction element contacts the rotor 14, which thereby begins to thermally expand the rotor 14 radially. Thus, this gap G is used to accommodate this thermal expansion of the rotor 14 if a size discrepancy develops between the outer periphery edge E1 of the hub 12 and the inner edge E2 of the rotor 14.

As a result, as the rotor 14 increases in temperature and expands radially, the hub 12 is able to remain relatively less affected by the heat transfer as a result of the interlocking lobes 18, 20 and the gap G. Acting both separately and in combination, both the interlocking lobes 18, 20 and the gap G act to prevent the rotor 14 from growing apart from the hub 12 during thermal yield conditions of the disc brake assembly 10. This permits the heated rotor 14 to run closer to a preferably lower melting temperature of the hub 12 without risking damage thereto and permits the hub 12 to function as a greater heat sink with increased thermal resistance.

In addition, the increases surface area between the outer peripheral edge E₁ of the hub 12 and the internal edge E₂ of the rotor 14 can increase the selection of materials that can be chosen for the hub 12 and rotor 14. For example, due to the high contact areas defined by the outer peripheral edge E₁ of the hub 12 and the internal edge E₂ of the rotor, aluminum may be used for the hub 12 to reduce the weight of the disc brake assembly 10.

Notwithstanding the radial play resulting from the gap G between adjacent, interlocking lobes 18, 20, the lobes 18 of the hub 12 and the lobes 20 of the rotor 14 prevent significant radial rotation therebetween. On the other hand, the disc brake assembly 10 further provides one or more fasteners 30 for preventing significant axial separation between the hub 12 and the rotor 14 (although only one fastener 30 is labeled in the figures for simplicity). More specifically, the fastener 30 extends through an orifice 32 extending through the hub 12.

In a preferred embodiment, the fastener 30 comprises a head 34 and a shaft 36, the head 34 being radially dimensioned larger than the shaft 36 and the shaft 36 being dimensioned to fit within the orifice 32 extending through the hub 12. As such, the head 34 is positioned on a first side 38 of the hub 12 while the shaft 36 extends through the hub 12 towards a second side 40 of the hub 12, the reference to the “first” side 38 and the “second” 40 being used generically and interchangeably. On the second side 40 of the hub 12, the shaft 36 is received by e.g. a washer 42, which is adapted for mating alignment with the shaft 36 of the fastener 30.

Preferably, a first length L₁ of the shaft 36 extending from a first surface 44 of the head 34 to a first surface 46 of the washer 42 is the same as or exceeds a width W_{H} of the hub 12. More preferably, a second length L₂ of the shaft 36 extending from the first surface 44 of the head 34 to a second surface 48 of the washer 42 that is opposite the first surface 46 of the washer 42 is the same as or exceeds the width W_{H} of the hub 12. As such, the length L of the shaft 36 will create a floating clearance A for and between the hub 12 and the rotor 14. Preferably, the floating clearance A is any distance that accommodates the thermal expansion or distortion of the rotor 14 during braking operations. In addition, the floating clearance A is shown as simultaneously existing on both the first side 38 of the hub 12 and the second side 40 of the hub 12, although it may be provided on only either side 38, 40 thereof or divided on either or both sides 38, 40 in equal or unequal divisions, as desired.

In any event, this floating clearance A permits axial float between the hub 12 and the rotor 14, as defined along their common axis. In other words, this floating clearance A permits slight relative axial movements between the hub 12 and the rotor 14, at least to the extent limited by the floating clearance A. And this axial float can also reduce the propensity for knockback. More specifically, it increases knockback resistance, which occurs if the friction element is pushed out of position, e.g. when cornering with a motorized vehicle. However, the axial float between the lobes 18 of the hub 12 and the lobes 20 of the rotor 14 allow the friction element to resist being pushed out of position and further preventing related problems, such as lever loss when cornering.

In addition, in another preferred embodiment, one or more springs (not shown) can also be installed within this floating clearance A to tighten the engagement between the fastener 30 and the hub 12, if desired, for example, to prevent or minimize rattling between the hub 12 and the rotor 14.

In addition, the head 34 of the fastener 30 is preferably at least as large radially as the first dimension d₁ in the neck portion 26 of the lobes 18, 20 in order to be able to hold the hub 12 and the rotor 14 together by overlap interfacing regions created thereby. More preferably, the head 34 of the fastener 30 is at least as large as the second dimension d₂ in the body portion 28 of the lobes 18, 20 in order to be able to hold the hub 12 and the rotor 14 together by overlap interfacing regions created thereby. And even more preferably, the head 34 of the fastener 30 is at least as large as the sum of the first dimension d₁ in the neck portion 26 of the lobes 18, 20 plus the second dimension d₂ in the body portion 28 of the lobes 18, 20 in order to be able to hold the hub 12 and the rotor 14 together by overlap interfacing regions created thereby. Thus, in a preferred embodiment, the head 34 of the fastener 30 is preferably at least as large radially to cover, or at least partially cover, at least one lobe 18 of the hub 12 and at least one lobe 20 of the rotor 14. Other possibilities are also expressly contemplated hereby.

Similarly, the size of the washer 42 is also suitably chosen, and, in a preferred embodiment, the head 34 of the fastener 30 is approximately the same radial size as the washer 42, although the invention is not limited in any way in this regard. Preferably, the washer 42 provides a similar function as the head 34 of the fastener 30 in so far as creating overlap interfacing regions between itself and the interlocking lobes 18, 20, albeit on opposing first and second sides 38, 40 of the hub 12.

In addition, the size of the fastener 30 and the size of the washer 42 are preferably chosen not to interfere with the flat annular braking surface 22 of the rotor 14, as preferably expressed between the internal edge E₂ and the outer peripheral edge E₃ of the rotor 14, although the invention is not limited in any way in this regard. Alternatively, the friction element can be adjusted accordingly.

In another preferred embodiment, the width W_{H} of the hub 12 preferably exceeds a width W_{R} of the rotor 14, although the invention is not limited in any way in this regard. For example, in such a preferred embodiment, this still allows axial float between the hub 12 and the rotor 14 even if the fastener 30 is designed without one or more floating clearances A. In other words, even if the first surface 44 of the head 34 of the fastener 30 immediately abuts the first side 38 of the hub 12 and/or the first surface 46 of the washer 42 immediately abuts the second side 40 of the hub 12, axial float can still be accomplished if the width W_{H} of the hub 12 exceeds the width W_{R} of the rotor 14, effectively creating alternative floating clearances not by the chosen dimensions about the fastener 30, but by virtue of the differing widths W_{H}, W_{R} of the hub 12 and the rotor 14, respectively, the fastener 32 otherwise immediately abutting the relevant surfaces thereof.

Preferably, the fasteners 30 axially join the hub 12 and the rotor 14, yet still permit some axial play therebetween, as defined by the floating clearance A. This play permits the rotor 14 to move or axially float about the hub 12 in relation to their common axis. In other words, the hub 12 and the rotor 14 are axially affixed, yet the rotor 14 is permitted to move or float in a limited axial manner with respect to the hub 12. Thus, the rotor 14 can move axially (i.e., along its axis of rotation) relative to the hub 12, and vice versa.

Other suitable types of fasteners 30 are also expressly contemplated hereby, including, for example, connection pins, connection bolts, rivets, or the like, as desired.

In any event, the hub 12 and the rotor 14 are attached by the interlocking lobes 18, 20, as described. As a result, the interlocking lobes 18,20 define an interactive driving connection between the hub 12 and the rotor 14, whereby rotation of the hub 12 drives rotation of the rotor 14, and retardation of the rotor 14 drives retardation of the hub 12, as previously described Accordingly, in a preferred embodiment, it is primarily the lobes 18, 20 that carry the respective torsional forces between the hub 12 and the rotor 14, and not the fasteners 30, which instead prevent the completed axial separation between the hub 12 and the rotor 14, but for providing the floating clearance A to define the axial float between the hub 12 and the rotor 14. Accordingly, in the preferred embodiment, there is little or minimal or no torque applied to the fasteners 30 as the disc brake assembly 10 axially rotates or retards with the hub 12 and rotor 14. Thus, the lobes 18, 20, and not the fasteners 30, are the torque bearing members in a preferred embodiment.

As described, the preferred disc brake assembly 10 of the present invention is an interlocking floating disc brake assembly 10 in which the rotor 14 is allowed to, at least to a limited extent, float freely axially and radially during a period of initial engagement when a friction element is applied to the flat annular braking surface 22 of the rotor 14. In other words, the rotor 14 is provided with limited floating freedoms of movement during at least an initial period of cooperative engagement between a friction element and the rotor 14 when the friction element is brought into frictional engagement with the rotor 14 to allow for axial and radial floating displacements of the rotor 14 as the braking forces are initially applied to the disc brake assembly 10 and thermal heat expansions begin to form about the rotor 14 and/or the hub 12.

It should be readily apparent that this specification describes exemplary, representative, and non-limiting embodiments of the inventive arrangements. Accordingly, the scope of this invention is not limited to any of these embodiments. Rather, the details and features of these embodiments were disclosed as required. Thus, many changes and modifications—as apparent to those skilled in the art—are within the scope of the invention without departing from the scope hereof, and the inventive arrangements necessarily include the same. Accordingly, to apprise the public of the spirit and scope of this invention, the following claims are made:

What is claimed is:

1. A floating disc brake assembly, comprising:
a rotatable brake hub adapted to rotate with an axle when said hub is connected to said axle, said hub having an outer peripheral edge; and
a rotor disposed circumferentially around said hub, said rotor having an internal edge that is in mating alignment with said outer peripheral edge through one or more interlocking lobes that are alternatingly disposed about said outer peripheral edge and said internal edge.

2. The floating disc brake assembly of claim 1, wherein at least one of said interlocking lobes is dimensioned to create a gap between said outer peripheral edge and said internal edge.

3. The floating disc brake assembly of claim 2, wherein said gap permits radial floatation between said hub and said rotor.

4. The floating disc brake assembly of claim 2, wherein said gap permits said rotor to expand radially during a thermal condition.

5. The floating disc brake of claim 2, wherein said gap absorbs heat generated by a friction element during a braking operation in order to retard heat flow from said rotor to said hub.

6. The floating disc brake assembly of claim 1, wherein at least one of said interlocking lobes provides an interactive driving connection between said hub and said rotor.

7. The floating disc brake assembly of claim 1, wherein at least one of said interlocking lobes transmits torque between said hub and said rotor.

8. The floating disc brake assembly of claim 1, further comprising one or more fasteners connecting said hub to said rotor.

9. The floating disc brake assembly of claim 8, wherein said fasteners restrict axial disengagement between said hub and said rotor.

10. The floating disc brake assembly of claim 8, wherein said fasteners permit axial floatation between said hub and said rotor.

11. The floating disc brake assembly of claim 1, wherein differing hub and rotor widths permit axial floatation therebetween.

12. The floating disc brake assembly of claim 1, wherein said hub and said rotor float radially relative to one another.

13. The floating disc brake assembly of claim 1, wherein said hub and said rotor float axially relative to one another.

14. The floating disc brake assembly of claim 1, wherein said hub and said rotor float radially and axially relative to one another.

15. The floating disc brake assembly of claim 1, wherein said assembly reduces failure of said rotor.

16. The floating disc brake assembly of claim 1, wherein said assembly reduces knockback.

17. The floating disc brake assembly of claim 1, wherein at least one of said interlocking lobes comprises a neck portion that is smaller than a body portion thereof.

18. The floating disc brake assembly of claim 1, wherein said interlocking lobes increase surface area contact between said hub and said rotor.

19. A floating disc brake assembly, comprising:
a rotatable brake hub adapted to rotate with an axle when said hub is connected to said axle; and
a rotor disposed circumferentially around said hub, said rotor attached to said hub by one or more interlocking lobes in mating arrangement extending therebetween.

20. The floating disc brake assembly of claim 19, wherein at least one of said interlocking lobes alternatingly extends about said hub and said rotor.

21. The floating disc brake assembly of claim 19, wherein if a thermal condition creates a radial size differential between said hub and said rotor, said interlocking lobes restrict radial separation between said hub and said rotor.
